(19) United States
(12) Patent Application Publication
(10) Pub. No.: US 2004/0249626 A1
(43) Pub. Date: Dec. 9, 2004

(54) Method for modifying English language compositions to remove and replace objectionable sexist word forms

(76) Inventor: Richard S. Neal, Edmond, OK (US)

Correspondence Address: James T. Robinson, EXCLUSIVITY-LAW, INC., 222 East Main Street, Norman, OK, 73060-1303, US

(21) Appl. No.: 10/453,239

(22) Filed: Jun. 3, 2003

(51) Int. Cl. G06F 17/20

(52) U.S. Cl. 704/1

(57) ABSTRACT

A method for removing objectionable sexist word forms from English language text and substituting new non-sexist word forms for the objectionable sexist word forms provides ten new blended word forms. Each new blended word form provides a non-sexist substitute for a word from ten associated sexist word pairs. If the gender of the being under consideration by the word from the sexist word pair is unknown, an appropriate new non-sexist word form is substituted for the objectionable sexist word form.

### BACKGROUND OF THE INVENTION

1. Field of the Invention

This invention relates generally to the field of language and, more particularly, but not by way of limitation, to a method for removing objectionable sexist word forms from English language compositions and replacing each objectionable sexist word form with an appropriate phonemically balanced non-sexist word.

2. Discussion

Objectionable sexist word forms (especially pronouns, nouns, and the possessive adjectives his and her) have plagued the English language for generations. In countless papers and documents written over the last 150 writers have used such phrases as “him or her,” “her or his,” or the awkward “their” in largely isolated attempts to avoid the problem of objectionable sexist language.

While the use of gender-inclusive phrases may be preferable to objectionable sexist language, the problem remains. These isolated attempts to avoid the problem of objectionable sexist language often create new problems, especially with people having limited fluency in the English language coupled with a heavy concentration of local dialect.

Because of a general lack of a suitable substitute, writers are both reluctant to employ the objectionable sexist language and also reluctant to fashion a remedy. Further, to avoid the clumsy, compounded, and awkward expressions referenced above, writers often resort to use of even larger words, or, in some cases, shortened and abbreviated words. Although every user of English is familiar with the problem of objectionable sexist language, a couple of illustrations are useful.

Entry rules for a contest may use “contestant” or “participant” repeatedly in an effort to avoid using “him or her” or “he or she”, etc. As a manager was heard to say, “If somebody decides not to participate then tell that somebody that that somebody doesn't have to.” Similar expressions are common in everyday English usage—both spoken and written.

All occurrences of “him” or “her” in English language composition are sexist, of course, but not all sexist occurrences are objectionable. If the being under consideration is clearly male (for example, George Washington), it would be completely appropriate (and non-sexist) to refer to him in a subsequent sentence. Likewise, it would be appropriate to refer to his horse or to his presidency. Similarly, a second reference to Emily Dickinson might refer to her poetry.

When gender is unknown, however, the use of multi-compounded expressions, the adoption of word forms from other contexts, and the interposition and repetition of needlessly larger word forms deny the English language (and writers of the English language) what is required—word forms which are simple, accurate, and easily expressed. After a century and a half, no set of words adequately solves the problem of sexist language. We are left with the following ten pairs of words which create difficulties:

him her (third person objective case)

his her (third person possessive adjective)

his hers (third person possessive pronoun)

he she (third person subjective case)

boy girl (gender specific but not case specific)

man woman (gender specific but not case specific)

men women (gender specific but not case specific)

himself herself (third person reflexive case)

father mother (gender specific not case specific)

Sir Madam (gender specific in address)

The ten pairs of words listed above represent the problem words of the English language except for combining forms (e.g., chairman/chairwoman, policeman, etc.). The terms word(s) and word form(s) are used interchangeably herein. Each word of the ten pairs of words listed above refers specifically to either male or female gender. When a word from the ten pairs of difficult words is used to form a combination word (e.g., chairman), the resulting combination word (also a word form) acquires the gender of the component difficult word.

In written English language text, the gender of the being under consideration is often obvious from the context. In other cases, the gender of the being under consideration is commonly known. If the sex of the being under consideration is male, then, obviously, the masculine word forms listed above are entirely appropriate. If the gender of the being under consideration is female, the feminine word forms listed above (and combinations containing those words) are appropriate. For example, George Sand is known to be a female author, so references to her would be entirely appropriate. Difficulties arise when the gender of the being under consideration is unknown. In this modern era, some individuals are androgynous and more than a few have undergone sex changes. As used herein, the term “unknown,” when used with respect to a being under consideration, includes those instances where an ambiguity exists as to the gender of the being under consideration.

Thus, “objectionable sexist language” refers to forms which arbitrarily identify a being under consideration as either male or female. The term “being under consideration” refers, if the objectionable sexist word form is a pronoun, to the pronoun's antecedent. For the possessive adjectives “his” and “her,” the term “being under consideration” refers to the antecedent of the possessive adjective. For the terms “Sir” and “Madam,” the term “being under consideration” refers to the person being addressed. Finally, for the gender-specific nouns “man,” “woman,” “boy,” “girl,” “mother,” and “father,” the term “being under consideration refers to the person being described by the gender-specific noun.

The terms “English language text” and “English language compositions” are used interchangeably herein to mean both existing English language works and English language works as they are being written.

The method for modifying English language compositions to remove and replace objectionable sexist references of the present invention substitutes non-sexist word forms for ten pairs of sexist words in a portion of English language text—but only if the gender of the being under consideration is unknown. The substituted non-sexist words are (1) phonemically balanced, (2) easily distinguished in both written and spoken English, (3) simple yet precise, and (4) easily expressed.

### SUMMARY OF THE INVENTION

Applicant's invention provides a method for removing objectionable sexist word forms from English language text and substituting new non-sexist word forms for the removed sexist word forms.

An object of the invention is to provide a separate blended word form to replace each of ten pairs of English language words whose usage frequently results in arbitrary assignment of gender to a being under consideration.

Another object of the invention is to provide a method of replacing objectionable sexist word forms with the blended word forms of applicant's invention.

Another object of the invention is to provide, for each pair of difficult English word forms, a blended word form which utilizes only the phonemes associated with the pair of difficult English word forms being replaced.

Another object of the invention is to provide, for each pair of difficult English word forms, a blended word form which uses only the letters common to the word pair.

Another object of the invention is to provide, for each pair of difficult English word forms, a blended word form which is easily spoken, written, and pronounced.

Another object of the invention is to provide, for each pair of difficult English word forms, a blended word form which is unique in the context in which a word from the word pair would be used.

Another object of the invention is to provide, for each pair of difficult English word forms, a blended word form which fits the way gender specific words in the word pair are used.

Another object of the invention is to provide, for each pair of difficult English word forms, a blended word form which is phonemically balanced.

Another object of the invention is to provide, for each pair of difficult English word forms, a blended word form which is balanced with respect to its constituent letters.

### BRIEF DESCRIPTION OF THE DRAWINGS

FIG. 1 lists ten pairs of sexist words in the English language and, for each pair of sexist words, a corresponding non-sexist replacement word according to the present invention.

FIG. 2 illustrates the incorporation of the replacement words in combination words of the English language containing the sexist words man/woman and men/women.

The following convention is used in the figures and in the detailed description of the invention that follows.

1. Sexist words that are being replaced appear in BOLD SMALL CAPS.

2. Non-sexist replacement words and combinations utilizing the non-sexist replacement words appear is BOLD ITALICS ALL CAPS.

### DETAILED DESCRIPTION OF THE INVENTION

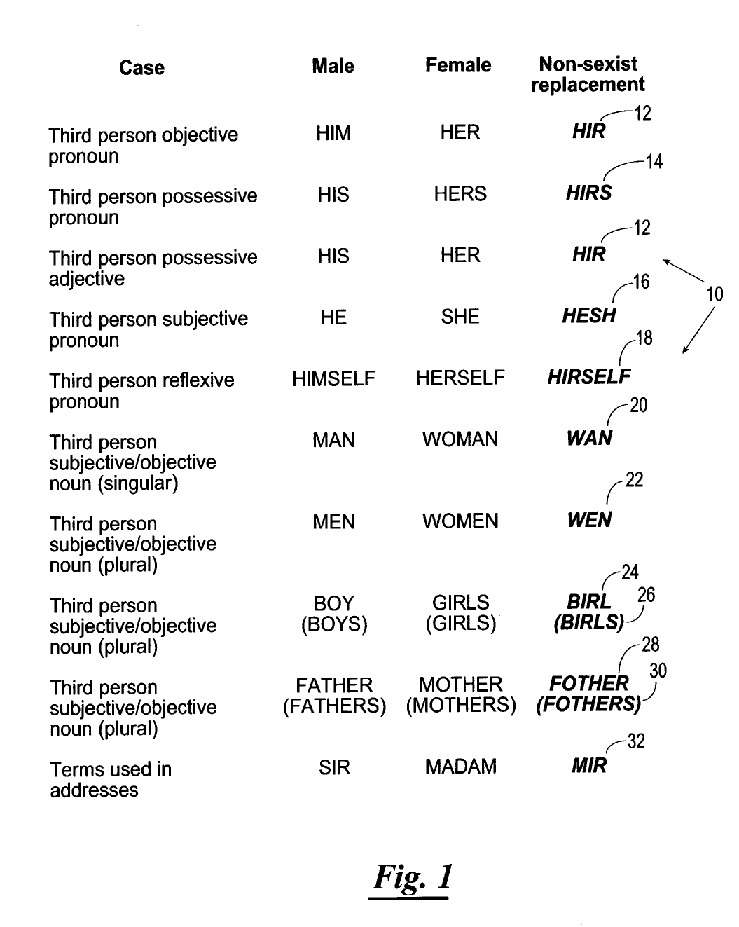

Referring now to FIG. 1, shown therein is a set of non-sexist replacement words (10) according to the present invention for incorporation into the English language in place of inappropriately used sexist word pairs currently in use.

A non-sexist word HIR (12) replaces the sexist third person objective pronouns HIM and HER. A non-sexist replacement word HIRS (14) replaces the sexist third person possessive pronouns HIS and HERS. A non-sexist replacement word HIR (12) replaces the sexist third person possessive adjectives HIS and HER.

Still referring to FIG. 1, a non-sexist replacement word HESH (16) replaces the sexist third person subjective pronouns HE and SHE. A non-sexist replacement word HIRSELF (18) replaces the sexist third person reflexive pronouns HIMSELF and HERSELF.

Still referring to FIG. 1, a non-sexist replacement word WAN (20) replaces the sexist third person subjective/objective sexist singular nouns MAN and WOMAN. A non-sexist replacement word WEN (22) replaces the sexist third person subjective/objective sexist plural nouns MEN and WOMEN.

Still referring to FIG. 1, a non-sexist replacement word BIRL (24) replaces the sexist third person subjective/objective singular nouns BOY and GIRL. A non-sexist replacement word BIRLS (26) replaces the sexist third person subjective/objective plural nouns BOYS and GIRLS.

Still referring to FIG. 1, a non-sexist replacement word FOTHER (28) replaces the sexist third person subjective/objective singular nouns FATHER and MOTHER. A non-sexist replacement word FOTHERS (30) replaces the plural FATHERS and MOTHERS.

In many religions, deities are referred to as “Father” (with a capital “F”). In some quarters, however, the gender of the deity is less certain. It will be understood by one skilled in the art that the non-sexist replacement word FOTHER can be used as either a common noun or as a proper noun (“Our Fother, which art in heaven”).

Still referring to FIG. 1, a non-sexist replacement word MIR (32) replaces the sexist words SIR AND MADAM, terms commonly used to speak or write directly to another.

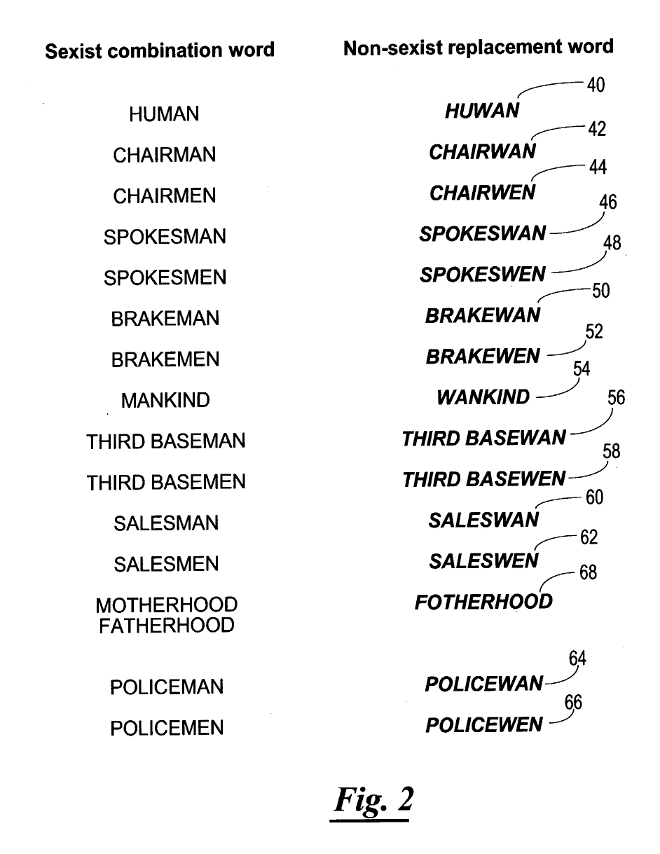

Referring now to FIG. 2, non-sexist word forms according to applicant's present invention are substituted for objectionable sexist portions of existing combination words to create non-sexist replacement combination words. The objectionable sexist combination word HUMAN is replaced by a non-sexist combination word HUWAN (40). The objectionable sexist singular word form CHAIRMAN is replaced by a singular non-sexist combination word form CHAIRWAN (42) and the objectionable sexist plural word form CHAIRMEN are replaced by CHAIRWEN (44). The sexist singular word form SPOKESMAN is replaced by a singular non-sexist combination word SPOKESWAN (46) and SPOKESMEN is replaced by a plural non-sexist combination word SPOKESWEN (48).

Still referring to FIG. 2, the singular sexist form BRAKEMAN is replaced by a singular non-sexist combination word BRAKEWAN (50), and the sexist plural form BRAKEMEN is replaced by a plural non-sexist combination word BRAKEWEN (52). The sexist form MANKIND is replaced by a non-sexist combination word WANKIND (54). The singular sexist form THIRD BASEMAN is replaced by a singular non-sexist form THIRD BASEWAN (56), and the plural sexist form THIRD BASEMEN is replaced by a plural non-sexist form THIRD BASEWEN (58).

Still referring to FIG. 2 the singular sexist combination word SALESMAN is replaced by a singular non-sexist combination word SALESWAN (60), and the plural sexist combination word SALEMEN is replaced by a plural non-sexist combination word SALESWEN (62). In a final illustration, the singular sexist combination word POLICEMAN is replaced by a singular non-sexist combination word POLICEWAN (64), and the plural combination word POLICEMEN is replaced by a plural non-sexist combination word POLICEWEN (66).

According to applicant's invention, the manager's clumsy sentence resulting from a desire to avoid using “he or she” repeatedly (“If somebody decides not to participate then tell that somebody that that somebody doesn't have to”) becomes “If HESH decides not to participate then tell HIR that HESH doesn't have to.”

It will be understood by one skilled in the art that applicant's invention relates to spoken and written English language wherein the speaker or writer does not know the gender of the being (i.e., the individual) under consideration and can not determine the gender of the being under consideration from the context of the English text. As explained above, it is completely appropriate to use gender-specific language if the gender of the individual under consideration is known.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A method for removing objectionable sexist word forms from a portion of English language text and substituting new non-sexist word forms for the removed sexist word forms, said method comprising the steps of:
a. Providing a non-sexist word HIR;
b. Searching the portion of English language text to locate each instance wherein the sexist word HIM is used in third person objective case;
c. Determining in each instance from the context whether the gender of the being referred to by the sexist word HIM is known or unknown;
d. Substituting said non-sexist word HIR for the sexist word HIM in each instance wherein the sexist word HIM is used in the third person objective case and, further, wherein the gender of the being referred to by the sexist word HIM is unknown;
e. Searching the English language text to locate each instance wherein the sexist word HER is used in third person objective case;
f. Determining in each instance from the context whether the gender of the being referred to by the sexist word HER is known or unknown; and
g. Substituting said non-sexist word HIR for the sexist word HER in each instance wherein the sexist word HER is used in third person objective case, and, further, wherein the gender of the being referred to by the sexist word HER is unknown.

2. A method for removing objectionable sexist words from a portion of English language text and substituting new non-sexist words for the removed sexist words, said method comprising the steps of:
a. Providing a non-sexist word HIRS;
b. Searching the portion of English language text to locate each instance wherein the sexist word HIS is used as a third person possessive pronoun;
c. Determining in each instance from the context whether the gender of the being referred to by the sexist word HIS is known or unknown;
d. Substituting said non-sexist word HIRS for the sexist word HIS in each instance wherein the sexist word HIS is used as a third person possessive pronoun, and, further, wherein the gender of the being referred to by the sexist word HIS is unknown;
e. Searching the English language text to locate each instance wherein the sexist word HERS is used as a third person possessive pronoun;
f. Determining in each instance from the context whether the gender of the being referred to by the sexist word HERS is known, known or unknown; and
g. Substituting said non-sexist word HIRS for the sexist word HERS in each instance wherein the sexist word HERS is used as a third person possessive pronoun, and further, wherein the gender of the being referred to by the sexist word HERS is unknown.

3. A method for removing objectionable sexist words from a portion of English language text and substituting new non-sexist words for the removed sexist words, said method comprising the steps of:
a. Providing a non-sexist word HIR;
b. Searching the portion of English language text to locate each instance wherein the sexist word HIS is used as a third person possessive adjective;
c. Determining in each instance from the context whether the gender of the being referred to by the sexist word HIS is known or unknown;
d. Substituting said non-sexist word HIR for the sexist word HIS in each instance wherein the sexist word HIS is used as a third person possessive adjective, and further, wherein the gender of the being referred to by the sexist word HIS is unknown;
e. Searching the English language text to locate each instance wherein the sexist word HER is used as a third person possessive adjective;
f. Determining in each instance from the context whether the gender of the being referred to by the sexist word HER is known or unknown; and
g. Substituting said non-sexist word HIR for the sexist word HER in each instance wherein the sexist word HER is used as a third person possessive adjective, and further, wherein the gender of the being referred to by the sexist word HER is unknown.

4. A method for removing objectionable sexist words from a portion of English language text and substituting new non-sexist words for the removed sexist words, said method comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

5. A method for removing objectionable sexist words from a portion of English language text and substituting new non-sexist words for the removed sexist words, said method comprising the steps of:
a. Providing a non-sexist word HIRSELF;
b. Searching the portion of English language text to locate each instance wherein the sexist word HIMSELF is used as a third person reflexive pronoun;
c. Determining in each instance from the context whether the gender of the being referred to by the sexist word HIMSELF is known or unknown;
d. Substituting said non-sexist word HIRSELF for the sexist word HIMSELF in each instance wherein the sexist word HIMSELF is used as a third person reflexive pronoun, and further, wherein the gender of the being referred to by the sexist word HIMSELF is unknown;
e. Searching the English language text to locate each instance wherein the sexist word HERSELF is used as a third person reflexive pronoun;
f. Determining in each instance from the context whether the gender of the being referred to by the sexist word HERSELF is known or unknown; and
g. Substituting said non-sexist word HIRSELF for the sexist word HERSELF in each instance wherein the sexist word HERSELF is used as a third person reflexive pronoun, and further, wherein the gender of the being referred to by the sexist word HERSELF is unknown.

6. A method for removing objectionable sexist words from a portion of English language text and substituting new non-sexist words for the removed sexist words, said method comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

7. A method for removing objectionable sexist words from a portion of English language text and substituting new non-sexist words for the removed sexist words, said method comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

8. A method for removing objectionable sexist words from a portion of English language text and substituting new non-sexist words for the removed sexist words, said method comprising the steps of:
a. Providing a non-sexist word FOTHER;
b. Searching the portion of English language text to locate each instance wherein the sexist word FATHER is used either as a third person subjective noun or as a third person objective noun;
c. Determining in each instance from the context whether the gender of the being referred to by the sexist word FATHER is known or unknown;
d. Substituting said non-sexist word FOTHER for the sexist word FATHER in each instance wherein the sexist word FATHER is used, either as a third person subjective noun or as a third person objective noun, and further, wherein the gender of the being referred to by the sexist word FATHER is unknown;
e. Searching the portion of English language text to locate each instance wherein the sexist word MOTHER is used either as a third person subjective noun or as a third person objective noun;
f. Determining in each instance from the context whether the gender of the being referred to by the sexist word MOTHER is known or unknown;
g. Substituting said non-sexist word FOTHER for the sexist word MOTHER in each instance wherein the sexist word MOTHER is used, either as a third person subjective noun or as a third person objective noun, and further, wherein the gender of the being referred to by the sexist word MOTHER is unknown.

9. A method for removing objectionable sexist words from a portion of English language text and substituting new non-sexist words for the removed sexist words, said method comprising the steps of:
a. Providing a non-sexist word FOTHERS;
b. Searching the portion of English language text to locate each instance wherein the sexist word FATHERS is used either as a third person subjective noun or as a third person objective noun;
c. Determining in each instance from the context whether the gender of the being referred to by the sexist word FATHERS is known or unknown;
d. Substituting said non-sexist word FOTHERS for the sexist word FATHERS in each instance wherein the sexist word FATHERS is used, either as a third person subjective noun or as a third person objective noun, and further, wherein the gender of the being referred to by the sexist word FATHERS is unknown;
e. Searching the portion of English language text to locate each instance wherein the sexist word MOTHERS is used either as a third person subjective noun or as a third person objective noun;
f. Determining in each instance from the context whether the gender of the being referred to by the sexist word MOTHERS is known or unknown;
g. Substituting said non-sexist word FOTHERS for the sexist word MOTHERS in each instance wherein the sexist word MOTHERS is used, either as a third person subjective noun or as a third person objective noun, and further, wherein the gender of the being referred to by the sexist word MOTHERS is unknown.

10. A method for removing objectionable sexist words from a portion of English language text and substituting new non-sexist words for the removed sexist words, said method comprising the steps of:
a. Providing a non-sexist word MIR;
b. Searching the portion of English language text to locate each instance wherein the sexist word SIR in the form of an address;
c. Determining in each instance from the context whether the gender of the being referred to by the sexist word SIR is known or unknown;
d. Substituting said non-sexist word MIR for the sexist word SIR in each instance wherein the sexist word SIR is used in the form of an address, and further, wherein the gender of the being referred to by the sexist word SIR is unknown;
e. Searching the portion of English language text to locate each instance wherein the sexist word MADAM is used in the form of an address;
f. Determining in each instance from the context whether the gender of the being referred to by the sexist word MADAM is known or unknown;
g. Substituting said non-sexist word MIR for the sexist word MADAM in each instance wherein the sexist word MADAM is used, and further, wherein the gender of the being referred to by the sexist word MADAM is unknown.

11. A method for removing objectionable sexist words from a portion of English language text and substituting new non-sexist words for the removed sexist words, said method comprising the steps of:
a. Providing a non-sexist word BIRL;
b. Searching the portion of English language text to locate each instance wherein the sexist word BOY is used either as a third person subjective noun or as a third person objective noun;
c. Determining in each instance from the context whether the gender of the being referred to by the sexist word BOY is known or unknown;
d. Substituting said non-sexist word BIRL for the sexist word BOY in each instance wherein the sexist word BOY is used, either as a third person subjective noun or as a third person objective noun, and further, wherein the gender of the being referred to by the sexist word BOY is either unknown or unknown;
e. Searching the portion of English language text to locate each instance wherein the sexist word GIRL is used either as a third person subjective noun or as a third person objective noun;
f. Determining in each instance from the context whether the gender of the being referred to by the sexist word GIRL is known or unknown;
g. Substituting said non-sexist word BIRL for the sexist word GIRL in each instance wherein the sexist word GIRL is used, either as a third person subjective noun or as a third person objective noun, and further, wherein the gender of the being referred to by the sexist word GIRL is either known or unknown.

12. A method for removing objectionable sexist words from a portion of English language text and substituting new non-sexist words for the removed sexist words, said method comprising the steps of:
a. Providing a non-sexist word BIRLS;
b. Searching the portion of English language text to locate each instance wherein the sexist word BOYS is used either as a third person subjective noun or as a third person objective noun;
c. Determining in each instance from the context whether the gender of the being referred to by the sexist word BOYS is known or unknown;
d. Substituting said non-sexist word BIRLS for the sexist word BOYS in each instance wherein the sexist word BOYS is used, either as a third person subjective noun or as a third person objective noun, and further, wherein the gender of the being referred to by the sexist word BOYS is either known or;
e. Searching the portion of English language text to locate each instance wherein the sexist word GIRLS is used either as a third person subjective noun or as a third person objective noun;
f. Determining in each instance from the context whether the gender of the being referred to by the sexist word GIRLS is known or unknown;
g. Substituting said non-sexist word BIRLS for the sexist word GIRLS in each instance wherein the sexist word GIRLS is used, either as a third person subjective noun or as a third person objective noun, and further, wherein the gender of the being referred to by the sexist word GIRLS is either known or.

13. The method of claim 1, further comprising the steps of:
a. Providing a non-sexist word HIR;
b. Searching the portion of English language text to locate each instance wherein the sexist word HIS is used as a third person possessive adjective;
c. Determining in each instance from the context whether the gender of the being referred to by the sexist word HIS is known or unknown;
d. Substituting said non-sexist word HIR for the sexist word HIS in each instance wherein the sexist word HIS is used as a third person possessive adjective, and further, wherein the gender of the being referred to by the sexist word HIS is either known or known;
e. Searching the English language text to locate each instance wherein the sexist word HER is used as a third person possessive adjective;
f. Determining in each instance from the context whether the gender of the being referred to by the sexist word HER is known or unknown; and
g. Substituting said non-sexist word HIR for the sexist word HER in each instance wherein the sexist word HER is used as a third person possessive adjective, and further, wherein the gender of the being referred to by the sexist word HER is unknown.

14. The method of claim 1, further comprising the steps of:
a. Providing a non-sexist word HIRS;
b. Searching the portion of English language text to locate each instance wherein the sexist word HIS is used as a third person possessive pronoun;
c. Determining in each instance from the context whether the gender of the being referred to by the sexist word HIS is known or unknown;
d. Substituting said non-sexist word HIRS for the sexist word HIS in each instance wherein the sexist word HIS is used as a third person possessive pronoun, and, further, wherein the gender of the being referred to by the sexist word HIS is unknown;
e. Searching the English language text to locate each instance wherein the sexist word HERS is used as a third person possessive pronoun;
f. Determining in each instance from the context whether the gender of the being referred to by the sexist word HERS is known or unknown or; and
g. Substituting said non-sexist word HIRS for the sexist word HERS in each instance wherein the sexist word HERS is used as a third person possessive pronoun, and further, wherein the gender of the being referred to by the sexist word HERS is unknown.

15. The method of claim 1, further comprising the steps of:
a. Providing a non-sexist word HESH;
b. Searching the portion of English, language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

16. The method of claim 1, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

17. The method of claim 1, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

18. The method of claim 3, further comprising the steps of:
a. Providing a non-sexist word HIRS;
b. Searching the portion of English language text to locate each instance wherein the sexist word HIS is used as a third person possessive pronoun;
c. Determining in each instance from the context whether the gender of the being referred to by the sexist word HIS is known or unknown;
d. Substituting said non-sexist word HIRS for the sexist word HIS in each instance wherein the sexist word HIS is used as a third person possessive pronoun, and, further, wherein the gender of the being referred to by the sexist word HIS is unknown;
e. Searching the English language text to locate each instance wherein the sexist word HERS is used as a third person possessive pronoun;
f. Determining in each instance from the context whether the gender of the being referred to by the sexist word HERS is known or; and
g. Substituting said non-sexist word HIRS for the sexist word HERS in each instance wherein the sexist word HERS is used as a third person possessive pronoun, and further, wherein the gender of the being referred to by the sexist word HERS is unknown.

19. The method of claim 3, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE In each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

20. The method of claim 3, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

21. The method of claim 3, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

22. The method of claim 2, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

23. The method of claim 2, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

24. The method of claim 2, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

25. The method of claim 4, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

26. The method of claim 4, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

27. The method of claim 6, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

28. The method of claim 13, further comprising the steps of:
a. Providing a non-sexist word HIRS;
b. Searching the portion of English language text to locate each instance wherein the sexist word HIS is used as a third person possessive pronoun;
c. Determining in each instance from the context whether the gender of the being referred to by the sexist word HIS is known or unknown;
d. Substituting said non-sexist word HIRS for the sexist word HIS in each instance wherein the sexist word HIS is used as a third person possessive pronoun, and, further, wherein the gender of the being referred to by the sexist word HIS is unknown;
e. Searching the English language text to locate each instance wherein the sexist word HERS is used as a third person possessive pronoun;
f. Determining in each instance from the context whether the gender of the being referred to by the sexist word HERS is known, known or unknown; and
g. Substituting said non-sexist word HIRS for the sexist word HERS in each instance wherein the sexist word HERS is used as a third person possessive pronoun, and further, wherein the gender of the being referred to by the sexist word HERS is unknown.

29. The method of claim 13, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE In each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

30. The method of claim 13, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

31. The method of claim 13, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

32. The method of claim 14, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

33. The method of claim 14, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

34. The method of claim 14, further comprising the steps of
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

35. The method of claim 15, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

36. The method of claim 15, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

37. The method of claim 16, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

38. The method of claim 18, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

39. The method of claim 18, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

40. The method of claim 18, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

41. The method of claim 19, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

42. The method of claim 19, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

43. The method of claim 20, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

44. The method of claim 22, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

45. The method of claim 22, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

46. The method of claim 23, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

47. The method of claim 25, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

48. The method of claim 28, further comprising the steps of:
a. Providing a non-sexist word HESH;
b. Searching the portion of English language text to locate each instance wherein the sexist word HE is used as a third person subjective pronoun;
c. Determining in each instance from the context whether the gender of the being referred to by the sexist word HE is known or unknown;
d. Substituting said non-sexist word HESH for the sexist word HE in each instance wherein the sexist word HE is used as a third person subjective pronoun, and further, wherein the gender of the being referred to by the sexist word HE is unknown;
e. Searching the English language text to locate each instance wherein the sexist word SHE is used as a third person subjective pronoun;
f. Determining in each instance from the context whether the gender of the being referred to by the sexist word SHE is known or unknown; and
g. Substituting said non-sexist word HESH for the sexist word SHE in each instance wherein the sexist word SHE is used as a third person subjective pronoun, and further, wherein the gender of the being referred to by the sexist word SHE is unknown.

49. The method of claim 28, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

50. The method of claim 28, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

51. The method of claim 29, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

52. The method of claim 29, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

53. The method of claim 30, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

54. The method of claim 32, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

55. The method of claim 32, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

56. The method of claim 33, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

57. The method of claim 35, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

58. The method of claim 38, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

59. The method of claim 38, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

60. The method of claim 39, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

61. The method of claim 41, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

62. The method of claim 44, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

63. The method of claim 48, further comprising the steps of:
a. Providing a non-sexist word WAN;
b. Searching the portion of English language text to locate each instance wherein the sexist word MAN is used either as a third person subjective noun or as a third person objective noun;
c. Determining in each instance from the context whether the gender of the being referred to by the sexist word MAN is known or unknown;
d. Substituting said non-sexist word WAN for the sexist word MAN in each instance wherein the sexist word MAN is used, either as a third person subjective noun or as a third person objective noun, and further, wherein the gender of the being referred to by the sexist word MAN is unknown;
e. Searching the portion of English language text to locate each instance wherein the sexist word WOMAN is used either as a third person subjective noun or as a third person objective noun;
f. Determining in each instance from the context whether the gender of the being referred to by the sexist word WOMAN is known or unknown;
g. Substituting said non-sexist word WAN for the sexist word WOMAN in each instance wherein the sexist word WOMAN is used, either as a third person subjective noun or as a third person objective noun, and further, wherein the gender of the being referred to by the sexist word WOMAN is unknown.

64. The method of claim 48, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

65. The method of claim 49, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

66. The method of claim 51, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

67. The method of claim 54, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.

68. The method of claim 58, further comprising the steps of:
a. Providing a non-sexist word WEN;
b. Searching the portion of English language text to locate each instance wherein the sexist word MEN is used either as a third person subjective noun or as a third person objective noun;
c. Determining in each instance from the context whether the gender of the being referred to by the sexist word MEN is known or unknown;
d. Substituting said non-sexist word WEN for the sexist word MEN in each instance wherein the sexist word MEN is used, either as a third person subjective noun or as a third person objective noun, and further, wherein the gender of the being referred to by the sexist word MEN is unknown;
e. Searching the portion of English language text to locate each instance wherein the sexist word WOMEN is used either as a third person subjective noun or as a third person objective noun;
f. Determining in each instance from the context whether the gender of the being referred to by the sexist word WOMEN is known or unknown;
g. Substituting said non-sexist word WEN for the sexist word WOMEN in each instance wherein the sexist word WOMEN is used, either as a third person subjective noun or as a third person objective noun, and further, wherein the gender of the being referred to by the sexist word WOMEN is unknown.
